(19) United States
(12) Patent Application Publication
(10) Pub. No.: US 2005/0144825 A1
(43) Pub. Date: Jul. 7, 2005

(54) Novelty stickers for buttons

(76) Inventor: Timothy Hopkins, Atlanta, GA (US)

Correspondence Address: CTS SOLUTIONS, LLC, 401 N. CROMWELL RD, UNIT Q3, SAVANNAH, GA, 31410, US

(21) Appl. No.: 10/750,753

(22) Filed: Jan. 2, 2004

(51) Int. Cl. G09F 3/10

(52) U.S. Cl. 40/638

(57) ABSTRACT

A novelty sticker that may be placed on a button so as to symbolize an unintended purpose for the button is disclosed. Preferably, the button is a car dashboard button, and more particularly the button is a “dummy” car dashboard button. The novelty design may symbolize, for example, oil slick, ejection seat, or smoke screen. Methods and apparatus are also disclosed.

### FIELD OF THE INVENTION

The present invention generally relates to novelty stickers, or decals. More specifically, the invention relates to stickers, or decals, that may be applied to buttons, such as dashboard buttons.

### DESCRIPTION OF THE RELATED ART

Automobiles, for example, often include buttons on their dashboards that have no intended purpose. These “dummy” buttons are often placed on the dashboard because they are assigned by the manufacturer to a particular function that some other model has, and this model does not. Alternatively, these buttons may be placed on the dashboard simply to take up unoccupied space. As to now there has been no such use by the user for these “dummy” buttons.

### SUMMARY OF THE INVENTION

Various embodiments of the present invention are illustrated in the present disclosure. A first embodiment of the invention is a method that includes applying a sticker to a button, whereby the sticker includes a novelty design that a person would recognize as not symbolic of the intended purpose of the button.

A second embodiment is a sticker for applying to a button. The sticker includes a novelty design that a person would recognize as symbolic of an unrealistic purpose for the button.

A third embodiment is a combination comprising: a dummy-dashboard button and a sticker applied to the button, wherein the sticker comprises a novelty design that a person would recognize as symbolic of an unrealistic purpose for the button.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention.

FIG. 1 is an illustration of various exemplary stickers, or decals, that may be placed on a button in accordance with embodiments of the present invention.

FIG. 2 is an illustration of a dashboard of an automobile that includes a plurality of buttons, one of which incorporates embodiments of the present invention.

### DETAILED DESCRIPTION

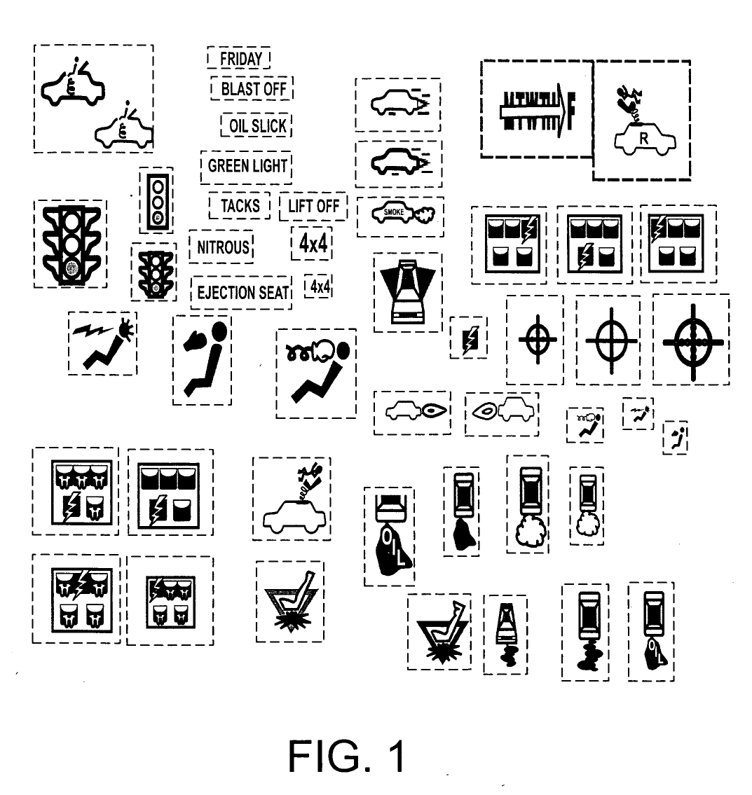

Referring now in more detail to the drawings, FIG. 1 illustrates various exemplary stickers, or decals, that may be placed on a button in accordance with embodiments of the present invention. As one can see, each sticker, or decal, includes a novelty design that a person would recognize as being an unrealistic function of a button, in particular a car dashboard button.

3M Corporation manufactures pressure-sensitive or pressure activated adhesives which are one example of the sticker, or decals, to be used in accordance with the present invention. Incorporated by reference herein in its entirety is 3M Instruction Bulletin 5.5, entitled “General Procedures for Interior and Exterior Dry Applications,” which is an application manual for applying these pressure-sensitive adhesives.

Various other types of stickers could be used. For example, decals that have designs printed on one side could be utilized. The decals could be opaque or translucent. On the opposing side may be an adhesive backing or may require a foreign adhesive to be applied.

It should be noted that the designs illustrated in FIG. 1 are merely exemplary. Certainly, one of skill in the art would appreciate that other designs could be utilized that would fall under the scope of the present invention.

Generally, each decal can be shaped to a size that would be conveniently placed over a button. Simply trimming the sticker, or decal, could provide for this shaping.

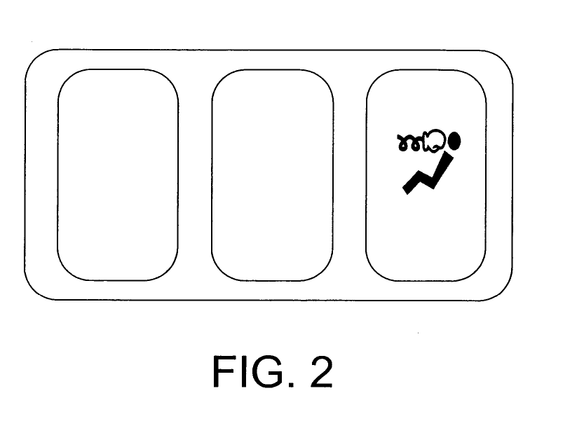

FIG. 2 is an illustration of a blow-up of a dashboard that includes a button incorporating embodiments of the present invention. The three buttons may be situated anywhere on the dashboard, or alternatively, on the center console of the car. It should be emphasized that car-dashboard buttons are simply a preferred embodiment. Certainly other buttons having no relation to car dashboards could be utilized.

As mentioned earlier, car dashboards often include “dummy” buttons that have no intended purpose, and may in fact be fixed. They are simply there. A sticker in accordance with embodiments of the present invention may be applied to one of these buttons. As such, a user can find novelty in these placed stickers, or decals.

It should also be noted that the present invention is not limited to “dummy” buttons. Novelty stickers in accordance with embodiments in the present invention may also be placed on buttons related to an intended purpose. In this manner, the sticker would overwrite the design already atop the button. Upon viewing this button, one would recognize that this button did not perform the purpose symbolized by the novelty design, as the design is fantasy or unrealistic. For example, the novelty design may symbolize an ejection seat, oil slick, cross-hairs, smoke-screen, etc. As one can see, these designs relate to unrealistic or fantasy functions.

Alternatively, the sticker may be designed to include one of the novelty designs illustrated in FIG. 1 along with an image that appears to be a button. These stickers could be placed anywhere (not necessarily atop a button) and create the illusion of a button.

It should be emphasized that the above-described embodiments of the present invention, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of the present invention and protected by the following claims.

1. A method, comprising:
applying a sticker to a dummy button, whereby the sticker includes a novelty design that a person would recognize as not symbolic of the intended purpose of the button.

2. The method of claim 1, wherein the button is a dashboard button.

3. (canceled)

4. (canceled)

5. (canceled)

6. (canceled)

7. A combination comprising:
a dummy-dashboard button; and
a sticker applied to the button, wherein the sticker comprises a novelty design that a person would recognize as symbolic of an unrealistic purpose for the button.
